(19) United States
(12) Patent Application Publication
(10) Pub. No.: US 2014/0161952 A1
(43) Pub. Date: Jun. 12, 2014

(54) MULTI-ZONE GRILL COOK AREA WITH THERMAL ISOLATION

(71) Applicant: Garland Commercial Industries, LLC, Freeland, PA (US)

(72) Inventor: Michael Robin SYKES, Orangeville (CA)

(73) Assignee: GARLAND COMMERCIAL INDUSTRIES, LLC, Freeland, PA (US)

(21) Appl. No.: 14/101,581

(22) Filed: Dec. 10, 2013

Related U.S. Application Data
(60) Provisional application No. 61/735,713, filed on Dec. 11, 2012.

(51) Int. Cl. A47J 37/06

(52) U.S. Cl. CPC A47J 37/06
USPC 426/523; 99/448

(57) ABSTRACT

The grill of the present disclosure provides a multi-zone cooking surface with separate, discrete zones that are thermally isolated from one another. This allows for cooking in only one zone while avoiding the problem of heat loss to adjacent zones that are not in use, or are operating at different or lower temperatures. The individual cooking zones are separated by a gap that is filled with a thermally insulating material. Each zone can have an independent associated temperature control.

### CROSS-REFERENCE TO RELATED APPLICATIONS

The present application claims priority to U.S. Provisional Patent Application No. 61/735,713, filed on Dec. 11, 2012, which is incorporated herein by reference.

### BACKGROUND OF THE DISCLOSURE

1. Field of the Disclosure

The present disclosure relates to grill cooking surfaces that have multiple heater-controlled cook plates or zones. More particularly, the present disclosure relates to grill cooking surfaces that have multiple plates or zones that are thermally isolated from one another.

2. Description of the Related Art

In currently available cooking devices, grill cook surfaces are one piece. An example of this setup is shown in FIG. 1, with grill 110. Heaters may be applied independently in separate areas or zones of cook surface 130 on an underside thereof, to cook food products placed on a top side of surface 130. (See, e.g., U.S. Pat. No. 7,082,941) However, the surface continuity of currently available devices (as in grill 110) allows for heat transfer to take place between cook zones, which can be undesirable. If adjacent cook zones are not turned on, cook performance in a particular zone will be compromised by heat loss to adjacent cold zones. One way to counter this effect is to turn on heat sources in all cook zones of the cook surface. This minimizes heat transfer, but is clearly a waste of energy.

Accordingly, there is a need to address these disadvantages of current devices.

### SUMMARY OF THE DISCLOSURE

The present disclosure provides a cooking grill comprising a chassis and a cooking surface, wherein the chassis supports the cooking surface. The cooking surface comprises at least two distinct and separate pieces of material, for cooking food products placed therein. Adjacent pieces of the cooking surface are separated by gaps, and can be bonded together with a thermally insulating material. Each of the pieces of the cooking surface may also have a heater or temperature controller associated therewith, which is controlled independently of other heaters and temperature controllers.

Thus, in one embodiment, the present disclosure provides a cooking apparatus, comprising a chassis and a plurality of separate and structurally distinct planar grill plates, wherein all of the plurality of said grill plates are within the chassis, and each pair of adjacent grill plates has a gap therebetween. The apparatus further comprises a plurality of heaters in the chassis, wherein each of the grill plates has a heater associated therewith, and wherein the heater provides heat to a side of the grill plate. The apparatus further comprises a thermally insulating bonding material in each gap, so that heat loss between adjacent plates is minimized.

In another embodiment, the present disclosure provides a method of operating cooking apparatus. The apparatus comprises a chassis, a plurality of separate and structurally distinct grill plates within the chassis, and a heater associated with each of the plurality of grill plates. The heater provides heat to its associated grill plate. The method comprises the steps of thermally insulating each of the plurality of grill plates, and controlling each of the heaters independently of one another, so that each of the grill plates can be operated at a different temperature.

### BRIEF DESCRIPTION OF THE DRAWINGS

FIG. 1 shows an exploded view of a cooking device according to the prior art, with a one piece cooking surface;

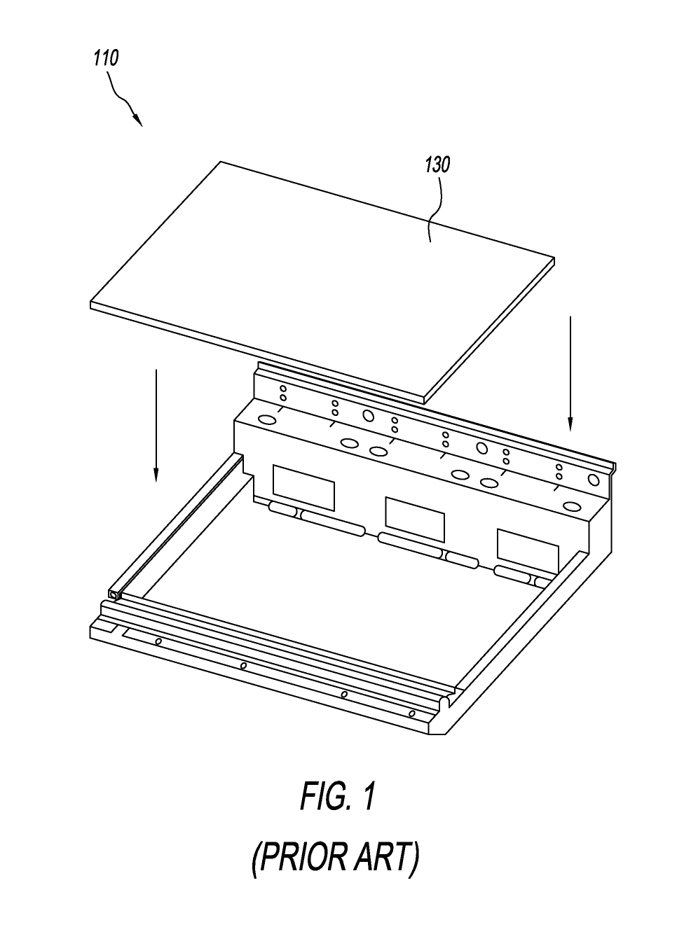

FIG. 2 shows an exploded view of the cooking apparatus of the present disclosure; and

FIG. 3 shows a schematic drawing of a gap between grill plates in the cooking apparatus of the present disclosure.

### DETAILED DESCRIPTION OF THE DISCLOSURE

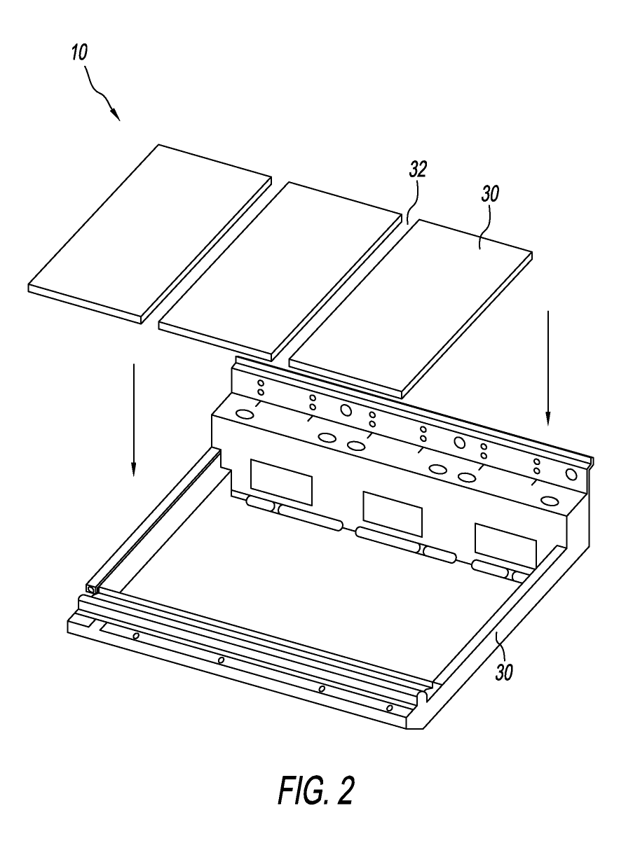

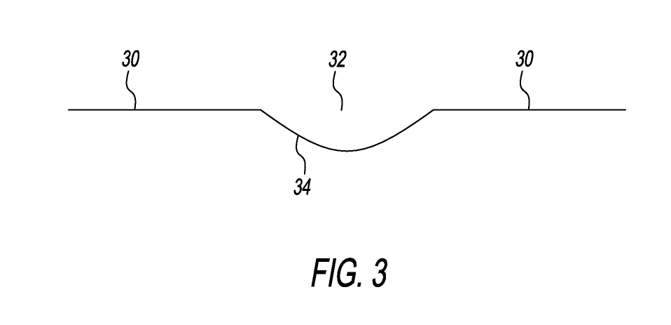

Referring to FIGS. 2 and 3, cooking apparatus 10 of the present disclosure is shown. Apparatus 10 has a single chassis 20 that holds a plurality of separate and distinct cooking plates or zones 30. In the shown embodiment, apparatus 10 has three separate cooking plates 30, but the present disclosure contemplates two or more (i.e., a plurality of) cooking plates 30. In apparatus 10, cooking plates 30 are separated by gaps 32.

Gaps 32 are filled (described in greater detail below) with a thermally insulating material 34, so that heat loss between adjacent cooking plates 30 is minimized if not entirely eliminated. Bonding of the adjacent cook plates 30 may also be just be a sealing of the gap. Insulating material 34 is food safe and able to endure high temperatures, allowing for the ability to sweep oils and greases into side grease containers, which aligns with current practice. Plates 30 are bonded to one another so that gap 32 has a width (the dimension between adjacent plates 30) of from one-sixteenth of an inch (0.0625″) to five-sixteenths of an inch (0.3125″), or any subranges therebetween.

This multi-zone arrangement allows a user to operate one cooking zone 30 independently of others, without the disadvantage of heat loss to adjacent plates 30. Apparatus 10 also eliminates the need to waste energy by operating heaters in adjacent plates 30 to minimize heat transfer, even when a food product is not being cooked in those adjacent zones. All of this takes place without compromising food safety or consistency of product cooked in the heated zone. The thermally insulating material 34 that bonds adjacent plates 30 also allows for contraction and expansion of the same.

Each of plates 30 may have a heater and temperature controller associated therewith (not shown), which may be located in or on chassis 20. The temperature of the grill plate can to be up to four hundred thirty-five degrees Fahrenheit. In one embodiment, the heaters associated with plates 30 adjacent to the ones in use can be turned off completely, to effect the energy savings. In another embodiment, they can be set to a reduced temperature, lower than what would be used during normal cooking operations. The controllers in different zones may also be set at different temperatures to cook different food products. Again, the ability to operate adjacent zones at different temperatures is possible because each of plates 30 are thermally isolated from one another, and there is no heat loss between them.

The thermally insulating material 34 is bonded to plates 30 and capable of withstanding thermal expansion and cycling. Each of plates 30 can in turn be mounted, connected, or mechanically attached to chassis 20. The thermally insulating material 34 will be applied so that it is level or slightly concave with respect to the cooking surface of adjacent plates 30 (as shown in FIG. 3). This allows a user to scrape grease or remaining food particle debris off of the cooking surface in the same way that this task is currently performed, for example by sweeping the debris off to a side of chassis 20. The thermally insulating material 34 should be applied so that the risk of the tool used to remove food debris and grease peeling away the material is minimized. The grease and food debris can be swept away to the outside edges or chassis 20 and into a front trough (not shown), but is not guided through gaps 32.

Some currently available devices attempt to deal with the heat loss problem by scoring or cutting grooves or slots into the cooking surface. The disadvantages of this technique, however, include the structural weakening of large cooking surfaces and a loss of cooking surface flatness. Other devices may have two separate cooking zones separated by grease collection buckets. Disadvantages of this latter concept include loss of cook surface due to extra grease buckets, inapplicability to applications where three platens or cook zones are needed, and the requirement to clean the grill surface between cook cycles, and having an extra grease container. Apparatus 10 addresses the problem of heat or energy loss in one-piece devices while still maintaining optimal performance and structural integrity of the cooking surface.

Previously, there was no impetus to change current cooking surface structures, because of a resistance in the field to implement measures that would add to the cost of the grill, as the present design using multiple plates 30 would. In addition, it was previously not thought possible that there would be a material that could withstand the rigorous demands presented by cooking applications. The materials exposed to the cooking process must be food safe, be able to withstand high temperatures (e.g. up to four hundred degrees Fahrenheit), be able to withstand contact with cleaning chemicals and animal fats, be easy to install, and last 10 years. The present disclosure has addresses all of these competing concerns.

In addition to the above-described performance requirements, the thermally insulating material 34 also needs to have a bonding capability, as the joint between the needs to be water tight, sealing the gap in the plates. The thermally insulating material 34 could be a polymer. Suitable thermally insulating materials 34 include a two-part epoxy resin, such as Master Bond® EP42HT-2FG, or a silicone-based or silane sealant, such as Dow Corning® 736. Cooking plates 30 can be made from any material suitable for use for contact with and in cooking food, such as steel or aluminum.

The multi-zone arrangement in grill 10 of the present disclosure could be used with a variety of grill surfaces, whether they would be made of homogeneous (e.g., steel or aluminum) composite, or laminate materials. The multi-zone arrangement of grill 10 may also be adapted for use in any type of grill zone heat source, whether electric (such as electric element or induction coils) or gas burners. Grill 10 may also be used with flat grills, clamshell grills, counter top grills, or free standing grills.

For ease of description, the term “heater” has been used in the present disclosure. The term “heater” can refer to electrical heating elements, gas-based or -powered burners, or induction heaters. In addition, the singular “heater” can also be a plurality of heaters—i.e., one or more, or each of cooking plates 30 can have a plurality of heaters associated therewith.

The present disclosure discusses applying thermally insulating material 34 to gaps 32, between adjacent plates 30. It is also contemplated that material 34 could be applied at the front or end of plates 30, between a front rail or backsplash of chassis 20, respectively. In current devices, the seams between the front and back of a grill plate and the chassis are welded joints to establish grease seals, and are thus not thermally insulating. If thermally insulating material 34 were applied at the front and back ends of plate 30, it could supply a thermal break, reducing heat loss through the front and rear connections of plate 30 as well.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiments) disclosed as the best mode contemplated for carrying out this disclosure.

What is claimed is:

1. A cooking apparatus, comprising:
a chassis;
a plurality of separate and structurally distinct planar grill plates, wherein all of said plurality of said grill plates are within said chassis, and each pair of adjacent grill plates has a gap therebetween;
a plurality of heaters in said chassis, wherein each of said grill plates has a heater associated therewith, wherein said heating element provides heat to a side of said grill plate; and
a thermally insulating bonding material disposed in each gap, so that heat loss between adjacent plates is minimized.

2. The cooking apparatus of claim 1, wherein said plurality of grill plates is three grill plates, and said plurality of heaters is three heating elements.

3. The cooking apparatus of claim 1, wherein each of said gaps between adjacent grill plates has a width of from one-sixteenth of an inch to five-sixteenths of an inch.

4. The cooking apparatus of claim 1, wherein said thermally insulating bonding material is an epoxy resin, a silicone-based sealant, or a combination of the two.

5. The cooking, apparatus of claim 1, wherein said thermally insulating material is applied in said gap so that it is level or concave with respect to a surface of the adjacent grill plates.

6. The cooking apparatus of claim 1, wherein said thermally insulating material forms a water-tight bond with each of the adjacent grill plates.

7. The cooking apparatus of claim 1, wherein at least one of said plurality of grill plates has a plurality of heaters associated therewith.

8. The cooking apparatus of claim 1, wherein each of said heaters are located between a bottom wall of said chassis and a bottom surface of the associated grill plate.

9. A method of operating a cooking apparatus, the apparatus comprising:
a chassis;
a plurality of separate and structurally distinct grill plates within said chassis; and
a heater associated with each of said plurality of grill plates, wherein said heater provides heat to its associated grill plate, the method comprising the steps of
thermally insulating each of said plurality of grill plates; and
controlling each of said heaters independently of one another, so that each of said grill plates can be operated at a different temperature.

10. The method of claim 9, wherein said thermally insulating step comprises the step of applying a bonding material to a gap between each adjacent pair of grill plates.

11. The method of claim 9, further comprising the step of heating a single one of said plurality of grill plates and not adjacent grill plates.

12. The method of claim 9, further comprising the step of heating a single one of said plurality of grill plates at a first temperature, and adjacent grill plates at a second temperature, wherein said first temperature is higher than said second temperature.
